(19) United States
(12) Patent Application Publication
(10) Pub. No.: US 2016/0037965 A1
(43) Pub. Date: Feb. 11, 2016

(54) BAKING PAN SPACER, COOLING RACK, SYSTEM AND METHOD

(71) Applicants: SAM LACARIA, Sterling Heights, MI (US); JACK ANTHONY GUERRA, Macomb, MI (US)

(72) Inventors: SAM LACARIA, Sterling Heights, MI (US); JACK ANTHONY GUERRA, Macomb, MI (US)

(21) Appl. No.: 14/815,573

(22) Filed: Jul. 31, 2015

Related U.S. Application Data
(60) Provisional application No. 62/033,928, filed on Aug. 6, 2014.

(51) Int. Cl. A47J 36/34; B65D 21/02; A47J 37/01

(52) U.S. Cl. CPC A47J 36/34; A47J 37/01; B65D 21/0233; B65D 21/0224

(57) ABSTRACT

A spacer apparatus for supporting first and second pans in spaced and inter-nesting arrangement, each of the pans having a base and outwardly flared sides with inner and outer side surfaces terminating in a top edge. A body having interconnected and elongated portions terminates in hooks at extending ends thereof. The hooks are adapted to engage perimeter displaced locations of the top edge and sides of a first pan and so that the elongated portions extend across an interior of the pan between the base and top edge. An underside of a second pan is arranged atop the first pan and adapted to contact the elongated portions so that the top edge and outer side surface of the second pan is upwardly spaced relative to the top edge and inner side surface of the first pan.

### CROSS-REFERENCE TO RELATED APPLICATIONS

This application claims the benefit of U.S. Provisional Application 62/033,928 filed on Aug. 6, 2014, the contents of which are incorporated herein in its entirety.

### FIELD OF THE INVENTION

This invention relates to a baking pan spacer apparatus for use in home and commercial kitchens that allows two or more baking pans to be firmly stacked one on top of another so as to conserve space, while allowing air to flow between the pans to provide for cooling of the contents.

### BACKGROUND OF THE INVENTION

In both residential and commercial kitchens, baking pans occupy large amounts of countertop and stove surface areas, particularly when multiple pans are being used at the same time. Baking pans are commonly designed so that they can be nested for storage when empty. However, when nested, the sidewalls of the stacked baking pans are typically in close contact, and do not allow for air to flow between the pans. Racks have been developed to hold a number of baking pans. However these racks tend to be large and to take up a lot of space. Also, a system is known for stacking pans containing baked goods by use of clips attached to the pan edges. This system has the disadvantages of requiring multiple clips between each pan, and also using a large amount of space between pans, as the bottom of one pan is held substantially above the top edge of the subjacent pan.

U.S. Pat. No. 6,557,720, issued to Tosdale et al. on May 6, 2003 describes a food pan that is formed such that there is at least one internal shoulder of each pan that extends inwardly from the walls of the pan at a position between the bottom of the pan and the top edge of the pan. The pan is also formed to include at least one external shoulder formed in the walls of the pan, such that when the pans are stacked, the external shoulder of one pan engages the internal shoulder of the subjacent pan.

U.S. Pat. No. 4,848,608, issued to Anderson, on Jul. 18, 1989 discloses a rack for holding baking pans. It provides for vertical rack members that are provided with multiple attachment points for horizontal rack members. The horizontal rack members are designed to hold baking pans. The multiple attachment points allow the distance between adjacent horizontal rack members to be adjusted, to accommodate pans of different heights.

U.S. Pat. No. 8,056,722 issued to Lonczak et al. on Nov. 15, 2011 describes a baking pan support clip for stacking one or more baking pans vertically to save spaced without contacting or damaging the contents of the stacked pans. Each clip is comprised of a thin, planar rigid bar having a vertical shaft, horizontal and vertical upper arms that contact and support the bottom surface and exterior sidewall of a baking pan and a base having a recess that secures the clips to the interior sidewall and lip bead of the lower pan. The base recess is shaped as a cylindrical channel to securely snap or fit over the lip bead of the baking pan to which the clip is attached.

There remains a need for a unitary, single-piece apparatus and system that allow for compact nesting of baking pans containing baked goods such that space is maintained between the sidewalls of adjacent stacked pans, thereby permitting air to flow between the pans for cooling of the baked goods.

### SUMMARY OF THE INVENTION

To achieve the above object, a first aspect of the present invention is characterized in that a spacer apparatus is used for vertically stacking a plurality of baking pans with tapered sidewalls while permitting air to flow between the pans. The spacer apparatus is formed of a heat-tolerant material and includes a resting portion having three or more spaced-apart hook portions configured and dimensioned to fit on top of a first baking pan with each of the hook portions resting on an upper edge of a sidewall of the baking pan. Each of the hook portions includes an outer end, an apex and an inner end disposed below the apex. The spacer apparatus further includes a pan-supporting portion interconnecting the inner ends of the hook portions, and disposed at a level below the apexes of the hook portions.

In addition to the first aspect hereof, a second aspect of the present invention is characterized in that when the spacer apparatus is placed on the first baking pan, the pan-supporting portion is disposed at a level spaced above and away from a bottom surface of the first baking pan.

In addition to the first aspect hereof, a third aspect of the present invention is characterized in that the inner ends of the hook portions extend downward and inward from the apexes of the hook portions towards the pan-supporting portion and away from the sidewalls. In this manner, a second baking pan resting on the pan-supporting portion will be spaced inwardly away from the sidewalls of the first baking pan, allowing air to flow between the sidewalls of the first baking pan and the sidewalls of the second baking pan.

In addition to the first aspect hereof, a fourth aspect of the present invention is characterized in that the pan-supporting portion is shaped substantially in the form of a Y, with one of the hook portions respectively disposed on each outer end of the pan-supporting portion.

In addition to the first aspect hereof, a fifth aspect of the present invention is characterized in that the pan-supporting portion is shaped in the form of an X, with one of the hook portions respectively disposed on each outer end of the pan-supporting portion.

In addition to the first aspect hereof, a sixth aspect of the present invention is characterized in that the pan-supporting portion is formed in a substantially rectangular shape having four corners, and wherein one of the hook portions is respectively connected to each of the corners of the pan-supporting portion.

In addition to the first aspect hereof, a seventh aspect of the present invention is characterized in that the spacer apparatus is a single continuous wire member joined end-to-end, having four hook portions and a modified rectangular shape.

According to the seventh aspect, the spacer apparatus further includes two outside connecting portions, each outside connecting portion having two ends interconnecting the outer ends of two of said hook portions. Each of the outside connecting portions forms a short side of the modified rectangular spacer apparatus.

Further according to the seventh aspect of the invention, the pan-supporting portion includes two inside connecting portions, each inside connecting portion having two ends interconnecting two inner ends of two of said hook portions. Each of the inside connecting portions together with the associated hook portions forms a long side of the modified rectangular spacer apparatus.

In addition to the seventh aspect hereof, an eighth aspect of the present invention is characterized in that each inside connecting portion is provided with a notch structure. Each notch structure extends along a plane parallel to the outside connecting portions towards a central portion of the baking pan spacer, such that the notch structures cooperate to define the pan-supporting portion. In this manner, a second baking pan placed on top of the baking pan spacer is supported by the notch structures.

In addition to the seventh aspect hereof, a ninth aspect of the present invention is characterized in that the inner ends of the hook portions extend downward and inward from the apexes towards the pan-supporting portion and away from the sidewalls. According to this aspect, a second baking pan resting on the pan-supporting portion will be urged away from the sidewalls of the first baking pan, allowing air to flow between the sidewalls of the first baking pan and the sidewalls of the second baking pan.

In addition to the seventh aspect hereof, a tenth aspect of the present invention is characterized in that a distance from apex-to-apex along the long side of the spacer apparatus is 9 15/16th inches, a height hₐ of each apex 24 above a plane of the inside connecting portions 16 is 1¼ inches, a length l_{icp} of each of the inside connecting portions 16 is 8½ inches, and a length lₛₛ of one of the short sides of the spacer apparatus is 7⅞th inches.

In addition to the first aspect hereof, an eleventh aspect of the present invention is characterized in that the baking pan spacer is formed from wire.

According to a twelfth aspect of the invention, a system of baking elements includes the spacer apparatus of the first aspect, and further includes a plurality of baking pans, each pan having a flat-bottomed surface and tapered sidewalls. The system is characterized in that the resting portion of the spacer apparatus is configured and dimensioned to fit on top of a first baking pan with each of the hook portions resting on an upper edge of a sidewall thereof, and a second baking pan, stacked on top of the spacer apparatus will be supported by the pan-supporting portion.

Further according to the twelfth aspect of the invention, the second baking pan will be urged away from the outer sidewalls of the first baking pan by the inner ends of the hook portions, such that there is a space for air to flow between the sidewalls of the first baking pan and the sidewalls of the second baking pan.

In addition to the twelfth aspect hereof, a thirteenth aspect of the present invention is characterized in that the inner ends of the hook portions extend downward and inward from the apexes towards the pan-supporting portion and away from the sidewalls.

In addition to the twelfth aspect hereof, a fourteenth aspect of the present invention is characterized in that the baking pans are round.

In addition to the twelfth aspect hereof, a fifteenth aspect of the present invention is characterized in that the baking pans are rectangular.

In addition to the twelfth aspect hereof, a sixteenth aspect of the present invention is characterized in that the system of baking elements further includes a storage rack configured to house at least four pans stacked vertically on top of one another with spacer apparatuses disposed therebetween.

A seventeenth aspect of the invention is characterized in that in a spacer apparatus for use in vertically stacking a plurality of baking pans while permitting air to flow between the pans, the spacer is formed as a unitary loop having a modified rectangular shape, and having two long sides, and two short sides interconnecting opposed ends of the long sides.

Further, according to the seventeenth aspect of the invention, each long side has a central portion and two ends each including a hook portion. Each hook portion has an inner end extending upward and outward from the central portion of the long side, an apex situated at an uppermost portion of the inner end and an outer end extending downward from the apex.

Further, according to the seventeenth aspect of the invention, the inner end of each hook and the central portion of the corresponding long side cooperate to define an oblique angle therebetween, and the outer end of each hook extends downward from the apex in a substantially vertical direction. Each of the short sides of the spacer apparatus connect lower ends of the outer ends of the corresponding hooks.

Further, according to the seventeenth aspect of the invention, the spacer apparatus is configured and dimensioned to fit on top of a first baking pan with each of the hook portions resting on an upper edge of a sidewall thereof, and to support a flat lower surface of a second baking pan below said upper edge and on top of the central portions of the long sides.

In addition to the seventeenth aspect hereof, an eighteenth aspect of the present invention is characterized in that when suspended from the first baking pan, the central portions of the long sides of the spacer apparatus are suspended at a suspension level below the upper edges of the first baking pan, and at a height h above the bottom surface of the first baking pan, such that, when the first and second baking pans have tapered sides, there is space for air to flow between the sides of the first baking pan, and the sides of a second baking pan, placed on the top of the baking pan spacer.

In addition to the eighteenth aspect hereof, an nineteenth aspect of the present invention is characterized in that the inner ends of the hook portions extend downward and inward from the apexes towards the central portions of the corresponding long sides and away from the sidewalls, such that a second baking pan resting on the pan-supporting portion will be urged away from the sidewalls of the first baking pan, thereby allowing air to flow between the sidewalls of the first baking pan and the sidewalls of the second baking pan.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 illustrates an embodiment of a spacer apparatus, according to an illustrative embodiment of the present invention, resting on the top edges of a baking pan;

FIG. 2 shows an embodiment of the spacer apparatus of FIG. 1 resting on a flat surface;

FIG. 3A is a top view of the spacer apparatus of FIGS. 1-2;

FIG. 3B is a side detail view of the spacer apparatus of FIGS. 1-2;

FIG. 3C is a top view of an alternative embodiment of the spacer apparatus;

FIG. 4A is a cross-sectional detail view of an embodiment of an edge portion of the spacer apparatus resting on a pan edge;

FIG. 4b is a detail view of the spacer apparatus of FIG. 2, showing a corner portion thereof;

FIG. 5 shows an embodiment of the spacer apparatus in a ninety degree rotated arrangement for resting on a relatively larger baking pan in comparison to the engagement configuration depicted in FIG. 1;

FIG. 6 is a cross-sectional view of an embodiment of the spacer apparatus being used in a nesting arrangement established between two baking pans;

FIG. 7 shows a second embodiment of the spacer apparatus having three equiangular extending legs and for use with a circular pan;

FIG. 8 shows a third embodiment of the spacer apparatus in the form of a pair of elongated and crosswise extending legs arranged in an X shape for use with a rectangular pan;

FIG. 9 shows a fourth embodiment of the spacer apparatus, again for use with a rectangular pan, and exhibiting reconfigured hook, apex and inner end portions along with additional crosswise extending and reinforcing wire frame supports; and

FIG. 10 illustrates a rolling rack apparatus adapted for supporting any plurality of baking pans and spacer apparatuses in tiered fashion according to the present inventions.

### DETAILED DESCRIPTION OF THE PREFERRED EMBODIMENTS

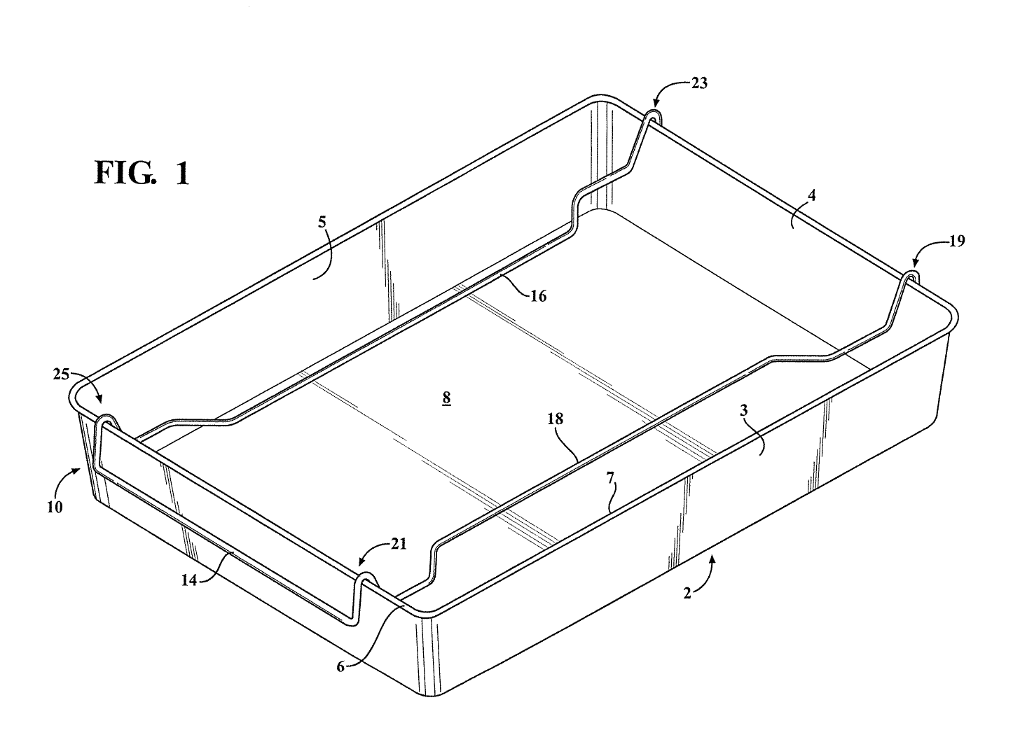

With reference to FIGS. 1-10, a series of illustrations are provided of a spacer apparatus for supporting any plurality of baking pans in tiered and partially inter-nesting fashion, this in order to facilitate a cooling airflow over and across the contents of each pan. It should further be understood that only structures and methodology needed for illustrating selected embodiments of the present invention are described herein and that other conventional structures, and those of ancillary and auxiliary components of the system, will be known and understood by those skilled in the art.

It is further understood that, for purposes of the present application, the definition of pan is understood to be interpreted to extend beyond it's normal dictionary definition, to with any broad, shallow container of metal, such usually having side flaring outward toward the top and which can be used in various forms for frying, baking, washing, etc. As such, the term pan as defined herein is understood to potentially include any other similar structure, not necessarily limited to a volume defining article with an open top, and such as which can include any plurality of individual and plural stackable (partially nesting) structures having a bottom and sides (not necessarily outwardly flared) utilized in holding any material or composition (not limited to edibles but perhaps including manufacturing parts supported within analogously configured trays or racks which are desired to be supported in partially nesting and inter-displaced fashion).

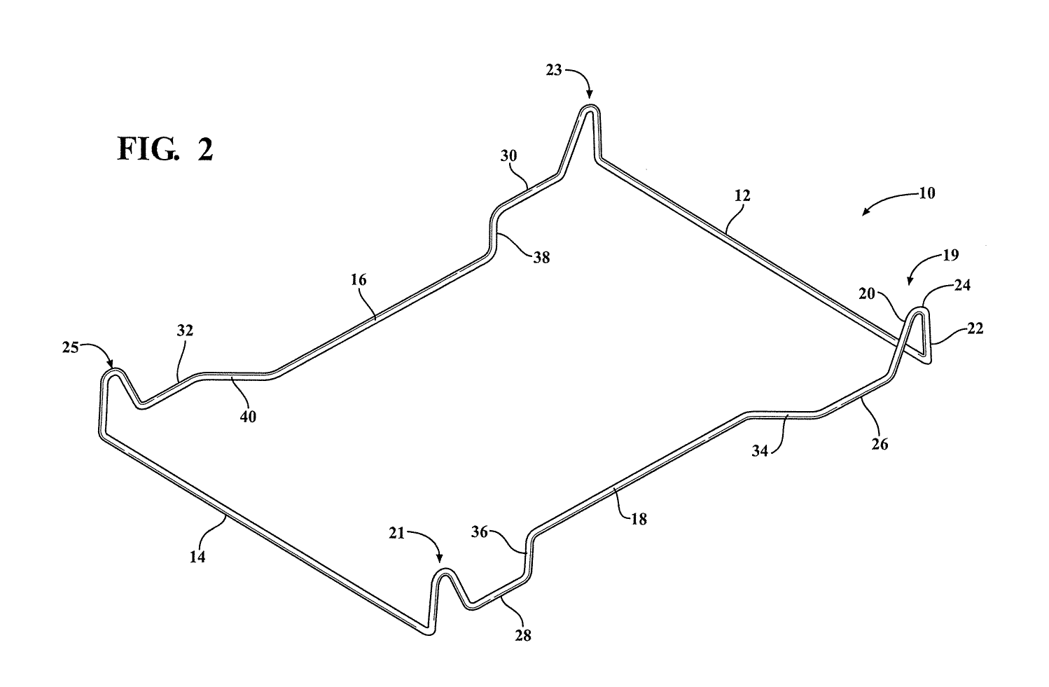

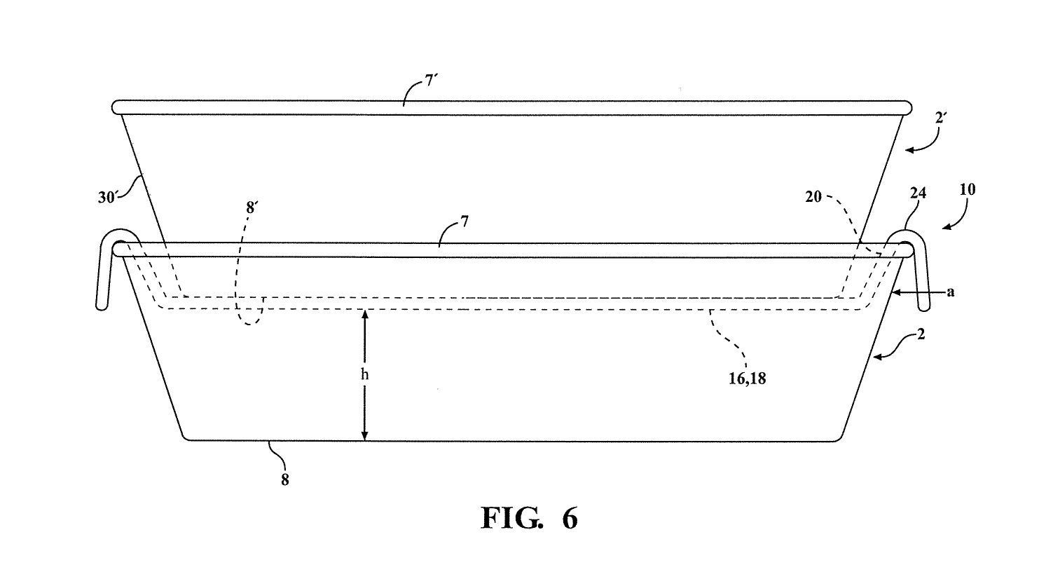

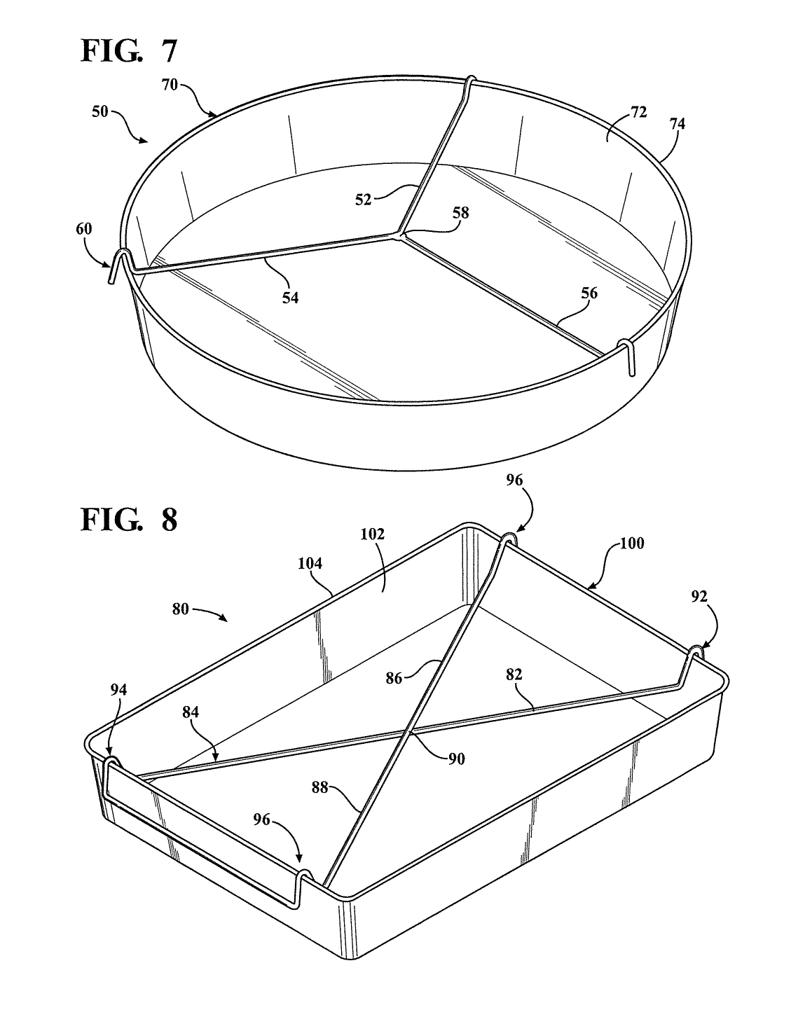

Referring initially to FIGS. 1 and 2, a unitary, single-piece wire spacer apparatus is generally illustrated at 10 which is supported upon a first pan 2 in partially recessed and extending fashion and for use in stacking a successively tiered and similarly configured and dimensioned pan (see related FIG. 6). In this fashion, any plurality of baking pans can be partially nested in multi-tier fashion with a successive wire spacer apparatus utilized between any two such tiered pans, and while providing space for air to flow between the pans 2. As is known, air flow between the baking pans 2 can be beneficial for the contents of the pans, for example, if the contents are hot and need to be cooled, or if the contents are being stored inside of a cooler and need to have air flow flowing there over in order to facilitate defrosting.

The spacer apparatus according to each of the several embodiments described herein permits stacking various shapes of baking pans, pots, cooking bowls, and other types of containers having tapered or otherwise inward extending sidewalls from top to bottom, and a substantially flat bottom surface. A preferred usage of each spacer apparatus is for stacking containers with prepared but uncooked food contents therein, such that air can flow between the sidewalls of the containers to cool the contents, for example baking pans, pizza pans and the like.

In the initial example of FIG. 1, the spacer apparatus 10 is in the shape of a modified rectangle, and formed of a heat-tolerant material, which may include but is not limited to metal wire. Other material constructions associated with the spacer apparatus can also include any of a thermoset plastic material, a ceramic with non-brittle properties or other cellulosic based and anti-inflammatory construction.

With further reference to succeeding FIGS. 2-4B, the spacer apparatus 10 is configured as an elongated and perimeter defining wire body exhibiting multiple bend locations. These may also include the configuration of hooks at opposite ends of the spacer apparatus which are supported upon selected perimeter edge locations of the pan, and so that elongated intermediate supporting portions of the spacer apparatus are in turn supported in recessed and extending fashion along a recessed interior of the pan, typically below the upper edge of its perimeter defining side wall, and in order to support an underside of a successively tiered and partially nested pan.

While it is understood that the spacer apparatus is not limited to any particular configuration, the initial example best shown in FIGS. 1-2 exhibits a four sided article with first and second opposite ends 12 and 14 interconnected by first and second sides (these referenced by inner most extending and intermediate connecting locations 16 and 18. A plurality of four hooks, at 19, 21, 23 and 25 are configured at each of the corner locations established between the sides and ends of the wire perimeter defining body and, as referenced by a selected one of the hook portions, each exhibits an inner end 20, an outer end 22, and an apex 24 integrally connecting the inner end 20 and outer end 22.

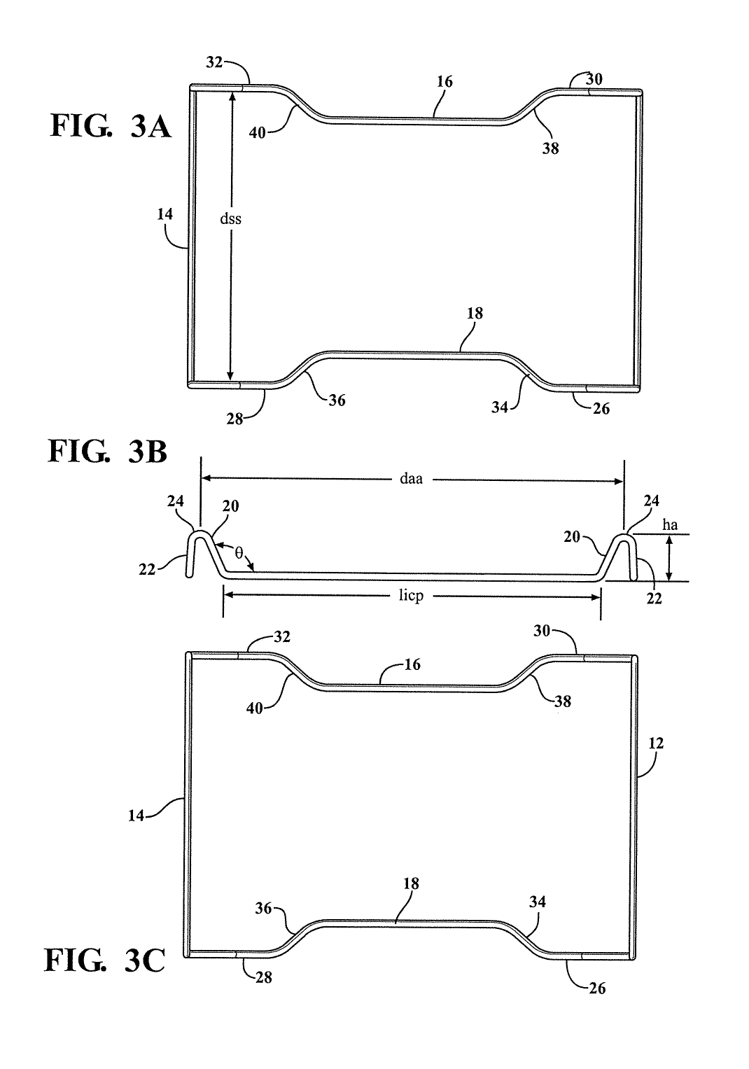

As best seen in FIGS. 2 and 3B, the inner end 20 of each hook 19, 21, 23 and 25 converges into an inside connecting portion (see at 26 in FIG. 2), this forming an oblique angle θ therebetween (see further FIG. 3B). As further shown in FIG. 2, the inside connecting portions are defined as pairs 26/28 and 30/32 extending from opposite respective ends of the intermediate side portions 16 and 18.

The inner end 20 of each hook 19, 21, 23, and 25 further extends upward and away from the corresponding inside connecting portion 26, 28, 30 or 32, along the same line as the inside connecting portion. As further shown, angled converging locations 34, 36, 38 and 40 are established between the inside connection portions 26-32 and the intermediate elongate extending sides 16 and 18. In this manner, each of the inside connecting portions together with each spaced apart pair of associated hook portions form one of the long sides of the spacer apparatus 10 exhibited at is most interior extending intermediate location by sides 16 and 18.

In this fashion, the inner end 20 of each corner defined hook extends upward from the corresponding inside connecting portion 26-32 to the apex 24 of the hook, with the outer end 22 of each hook extending downwardly in a substantially vertical direction from the apex 24 of the hook portion. The outside ends (or outside connecting portions 12 and 14), form short sides of the modified rectangular spacer apparatus 10, with each connected to a lower end of an outer end 22 of a hook portion. In the embodiment of the invention as shown in FIGS. 2, 3A and 3B, the outside connecting portions 12 and 14 extend in a direction perpendicular to the inside connecting portions 26-32, and in a plane connecting each pair 26/28 and 30/32 of the inside connecting portions.

According to this arrangement, as shown in FIG. 2, the spacer apparatus 10 would lie flat on a flat surface, with the four hook portions rising above the level of the flat surface, and further such that the elongated intermediate portions (including but not limited to the central elongated portions 16 and 18) extend across an interior of the pan between the base surface of the pan and its top edge. Without limitation, the outside connecting portions 12 and 14 can extend in a plane above or below the plane of the inside connecting portions 26-32, and without impacting the operation of the spacer apparatus 10. As can best be seen in FIGS. 2 and 3A, the intermediate extending side portions 16 and 18 extend inward along the plane connecting each opposite pair of inside connecting portions 26/28 and 30/32, and in order to provide a secure ledge for supporting a successively tiered baking pan on top.

Referring again to FIG. 1, each baking pan 2, has interconnecting sidewalls 3, 4, 5 and 6, these extending between an uppermost contiguous and perimeter defining edge 7 and a converging bottom 8 of the pan, further such that the sidewalls 3-6 each exhibit inner and outer surfaces and are tapered to extend upward and outward therefrom. The spacer apparatus 10 is further configured and dimensioned to fit on top of the baking pan 2, with each of the hook portions resting upon and along locations of the perimeter defining upper edge 7 of selected sidewalls (see at 4A and 6 in FIG. 1) thereof.

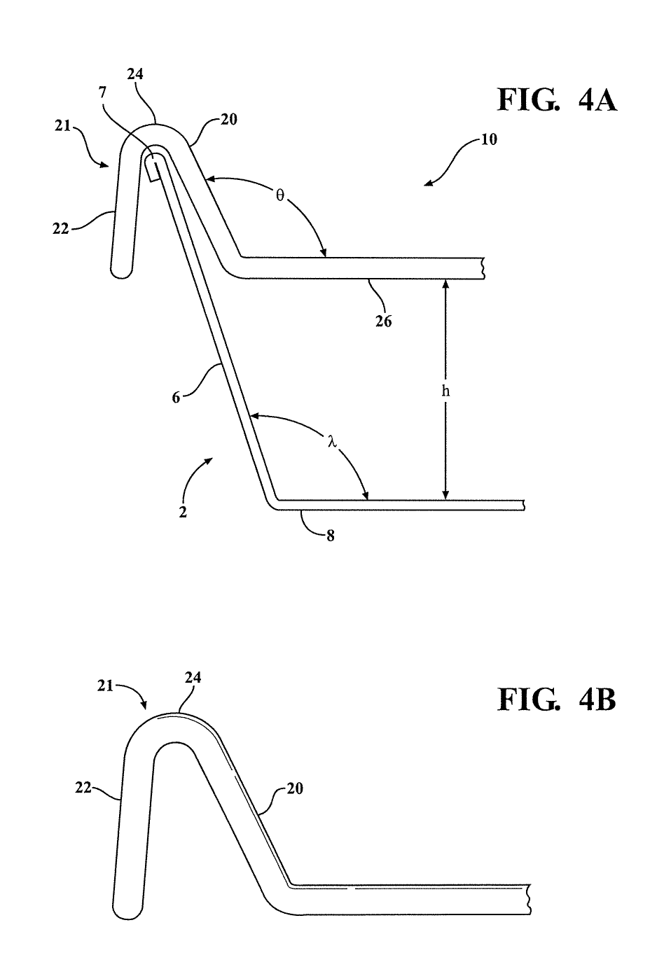

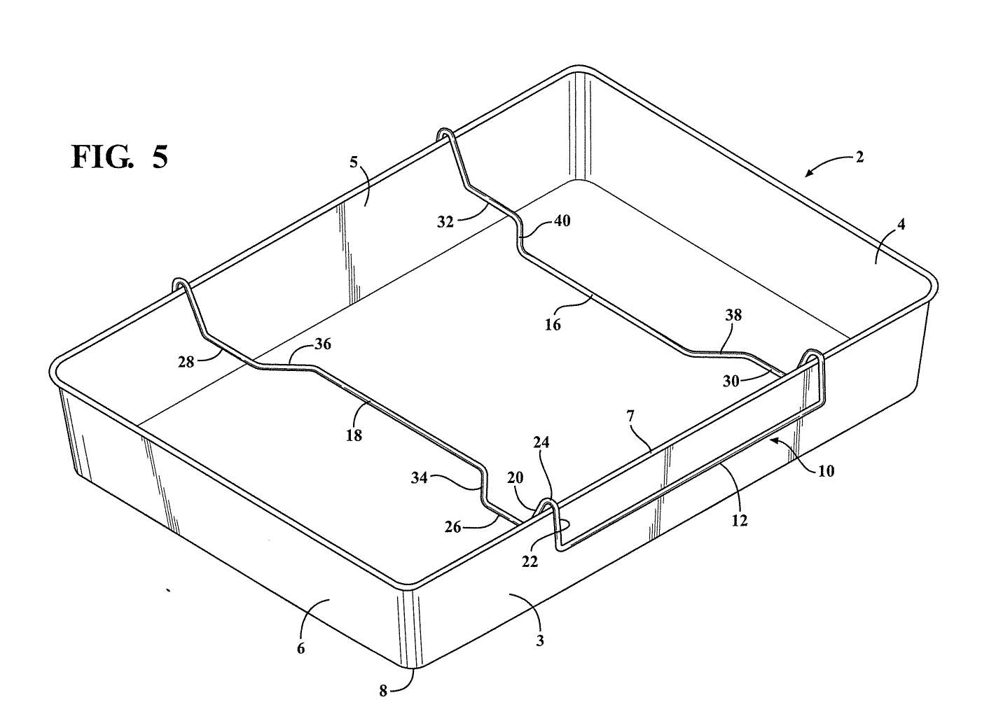

As best referenced in FIG. 4A, when the spacer apparatus 10 is resting on the baking pan 12, the inner side 20 of each hook portion extends downward and away from the corresponding sidewall 30 of the baking pan 12. The length of the inner side 20 of each hook portion 18 is such that the inside connecting portion 26-32 is suspended below the upper edge (see at 7) of the baking pan 2, at a height h (FIG. 4A) above the bottom surface 8 of the pan. The height h can be determined, such that, for example, the bottom of the pan-supporting portions (inter most and intermediate extending sides 16 and 18) of the spacer apparatus 10 does not come in contact with the contents of the baking pan 2.

As further shown, the inside connecting portions 26/28 and 30/32 extend in a plane substantially parallel to the plane of the bottom surface 8 of the baking pan 2. Thereby, the angle θ between the inner side 20 (of each of the four corner configured hooks 19, 21, 23 and 25) and their associated inside connecting portions 26/28 and 30/32 of the spacer apparatus 10, is greater than an angle 2, between the upper sidewall extending edge and bottom surface of the baking pan 2.

In one non-limiting embodiment, the distance dₐₐ from apex 24 to apex 24 along one of the long sides of the spacer apparatus 10 is 9 15/16th inches (FIG. 3B), the height hₐ of each apex 24 above the plane of the inside connecting portions 26-32 is 1¼ inches, the length l_{icp} of one of the inside connecting portions (e.g. at 26) is 8½ inches, and the length lₛₛ of one of the short sides of the spacer apparatus is 7⅞th inches, (FIG. 3A).

The spacer apparatus 10, as described above, may be constructed of a heat resistant material. For example, the spacer apparatus may be constructed as a unitary bent wire. Although shown as a continuous loop in, for example, FIG. 2, it can be understood that the structure is not limited to continuous loop structures. For example, the loop could be open at one of the short sides of the spacer apparatus, as shown in FIG. 3C.

Also, as shown in FIG. 1, the spacer apparatus 10 is dimensioned such that the inside connecting portions 26-32 of the spacer apparatus 10 are proximate the parallel extending sidewalls 3, 4, 5 and 6. However, other configurations are possible. For example, and as further shown in FIG. 5, the spacer apparatus 10 can be suspended on a baking pan 2, such as which may exhibit dimensions substantially larger than the spacer apparatus 10, such that the spacer apparatus 10 is rotated at a ninety degree offset relative to that arrangement depicted in FIG. 1 and so that it is located in a center area of the baking pan 12, with the inside connecting portions 26-32 being spaced away from the parallel extending sidewalls (again at 3 and 5) of the baking pan 12.

FIG. 6 illustrates the stacking of two baking pans 2, 2′, by using the spacer apparatus 10. The spacer apparatus 10 rests on the lower or initial baking pan 2 such that the apex 24 of each hook portion rests on the upper edge 7 of the baking pan 2 as described above. In order to stack the baking pans 2, 2′, et seq., the upper tiered baking pan 2′ is placed on top of the spacer apparatus 10, such that a bottom surface 8′ of the baking pan 2′ rests upon the inner extending and supporting portions of the apparatus 10 again depicted by the top of the inside connecting portions 26/28 and 30/32, the bended portions 34/36 and 38/40 and inner most and intermediate extending supports 16 and 18 of the spacer apparatus 10.

As discussed above, the inner sides 20 of the hooks 19, 21, 23 and 25 extend downward and away from the corresponding sidewalls 3, 4, 5 and 6. In this manner, the baking pan 2′, when placed on top of the spacer apparatus 10, will be spaced upwardly a selected distance from the lower baking pan 2, thereby creating a space of width “a” between the sidewalls of the first baking pan 2 and the sidewalls of the second baking pan 2′. This spacing between the sidewalls of the stacked baking pans 2, 2′ allows air to flow between the sidewalls of the baking pans 2, 2′. Note also that due to the tapering of the sidewalls (see again each of 3, 4, 5 and 6 for each backing pan), the potential width “a” between the sidewalls of the stacked baking pans 2, 2′ depends on the height “h”, where the height “h” is the height of the inside connecting portions (26/28 and 30/32) above the bottom 8 of the baking pan 2.

FIGS. 7-9 illustrate specific examples of several potential alternate embodiments of the spacer apparatus 10 and which, as will be described, can include any configuration of spacer body having elongated and interconnected portions not limited to the closed perimeter configuration of FIG. 1 in use with a rectangular shaped pan. In each of the alternate embodiments described below, the hooks have the same structure as those described in the initial embodiment of FIGS. 1-6 (see at 20, 22 and 24 for each corner located hook portion) described above, and therefore will not be described in detail in reference to the following embodiments.

FIG. 7 illustrates a second embodiment of a spacer apparatus 50 comprising a pan-supporting portion having three equiangular extending connecting portions 52, 54 and 56 extending between an interior center or conjoining midpoint 58 and each three outer hooks 60 disposed at outer ends of each of the three inside connecting portions 52, 54 and 56. A baking pan 70 is round, having a tapered sidewall 72. The tapered sidewall 72 has an upper edge 74. The spacer apparatus 50 is configured and dimensioned to fit on top of the baking pan 70 with each of the hook portions 60 resting on the upper edge 74.

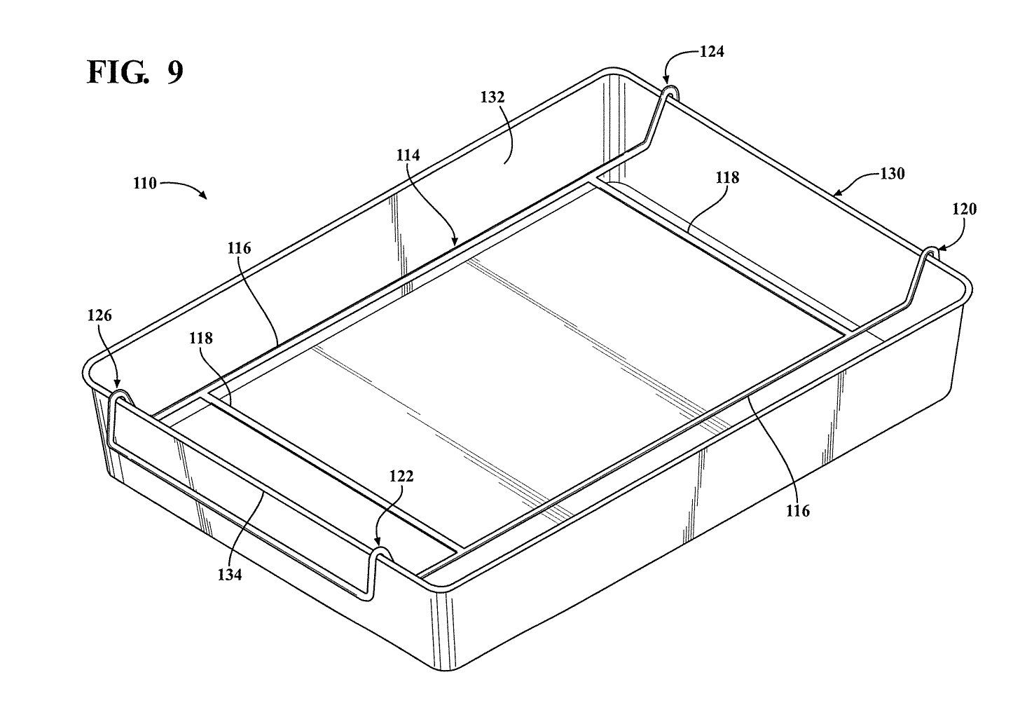

FIG. 8 illustrates a third embodiment of a spacer apparatus 80 in the form of a pair of elongated and crosswise extending legs arranged in an X shape to define segmented portions 82/84 and 86/88, these intersecting at a central midpoint 90 and extending outwardly to four corner located hooks 92, 94, 96 and 98. As with the initial embodiment of FIGS. 1-6, the spacer apparatus 80 is configured for use with a rectangular pan (see at 100) in which the segmented portions define a pan-supporting locations, and with the four hooks 92, 94, 96 and 98 (similarly constructed as described in preceding embodiments) disposed at outer ends of the each of the four inside connecting and segmented portions 82/84 and 86/88.

As described, the baking pan 100 is rectangular, having tapered sidewalls 102. The tapered sidewalls 102 have upper edges 104. The spacer apparatus 80 is configured and dimensioned to fit on top of the baking pan 100 with each of the hook portions 90 resting on one of the upper edges 104.

FIG. 9 illustrates a fourth embodiment of a spacer apparatus 110 comprising a pan-supporting portion 114. The pan-supporting portion 114 includes two inside connecting portions 116 and two crossbars 118 which function as additional crosswise extending and reinforcing wire frame supports. The inside connecting portions 116 are disposed parallel to each other and have two outer ends. The crossbars 118 are perpendicular to the inside connecting portions, and extend between and connect the two inside connecting portions 116. The spacer apparatus 110 includes four hooks 120, 122, 124 and 126 disposed at outer ends of each of the two inside connecting portions 116.

A baking pan 130 is rectangular, having tapered sidewalls 132. The tapered sidewalls 132 have upper edges 134. The spacer apparatus 110 is configured and dimensioned to fit on top of the baking pan 130 with each of the hooks 120, 122, 124 and 126 resting on each of the four interconnecting upper edges 134.

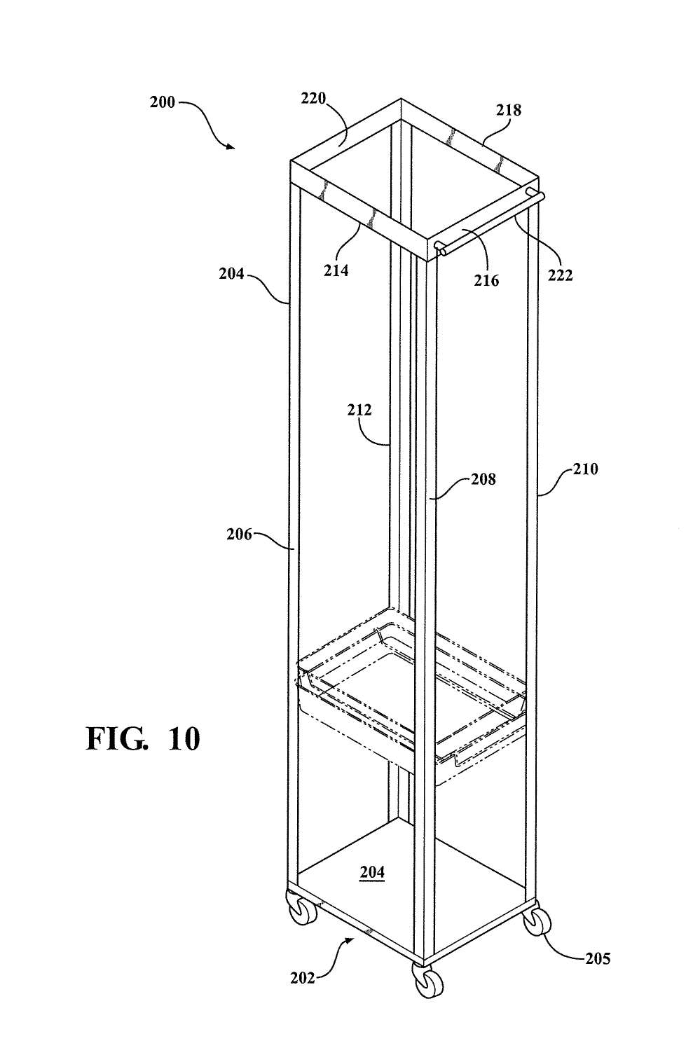

Finally, and referring to FIG. 10, a rolling rack apparatus 200 is illustrated according to another embodiment of the invention and which is utilized with any plurality of tiered baking pans and spacer apparatuses as described herein. In an exemplary embodiment but non-limiting embodiment, the rack apparatus 200 may be formed from steel, aluminum or an aluminum alloy. Alternatively, the rack apparatus 200 may be formed from a high-strength plastic.

The rack apparatus 200 is usable to vertically stack a large number, such as for example, a number between 10 and 20 of rectangular deep-dish cooking pans in, with each of the pans having a spacer apparatus on top of the pan, and below the pan above, except for the uppermost pan. Reference is made to a plurality of pans, such as which have been previously illustrated in FIG. 6, and which are drawn in phantom in relation to the rack apparatus 200.

As further shown, the rack apparatus 200 includes a base portion 202 including a floor portion 204 or a metal support structure extending across the bottom of the base portion. Wheels 205 or casters are provided on the bottom corners of the base portion 202 to facilitate rolling movement of the rack. The rack apparatus 200 also includes four elongated and vertically extending identical members 206, 208, 210 and 212 which are formed from angled metal parts exhibiting an L-shaped cross-section, these oriented with the corners of the L facing outwardly and so that the elongated members establish an open interior above the base or floor portion 204.

Reinforcing support members 214, 216, 218 and 220 may be provided at the top of the rack apparatus in end to end and perimeter defining fashion which connect upper extending ends of the elongated members 206, 208, 210 and 212 together. Each rack apparatus 200 is provided with a handle (see at 222) attached to one of the support members (at 216) at the top of the rack apparatus.

Without limitation, the rack apparatus 200 may be between four and six feet in height, or other dimensions as preferred by a user. It will be understood that a large number of uncooked and prepared pizzas or other food items may be stacked in a number of these rack apparatus 200 along with any variation of tier defining and partially nesting spacer apparatuses (see at 10, 50, 80, and 110), as previously described and illustrated such that the spacer and rack apparatuses can provide a kit, and they may be stored together side-by-side in a walk-in cooler to allow rapid preparation of the food during the dinner hour or other rush period.

Having described our invention, other embodiments will become apparent to those skilled in to the art to which it pertains, and without deviating from the scope of the appended claims.

We claim:

1. A spacer apparatus for supporting first and second pans in spaced and inter-nesting arrangement, each of the pans having a base and outwardly flared sides with inner and outer side surfaces terminating in a top edge, said apparatus comprising:
a body having interconnected and elongated portions terminating in hooks at extending ends thereof;
said hooks adapted to engage perimeter displaced locations of the top edge and uppermost adjoining side surfaces of a first pan and so that said elongated portions extend across an interior of the pan between the base and top edge; and
an underside of a second pan arranged atop the first pan and adapted to contact said elongated portions so that the top edge and outer side surface of the second pan is upwardly spaced relative to the top edge and inner side surface of the first pan to permit airflow between therebetween.

2. The spacer apparatus as described in claim 1, each of said hooks further comprising an outer end, an apex and an inner end disposed below said apex.

3. The spacer apparatus as described in claim 1, further comprising said body being formed of a heat-tolerant material.

4. The spacer apparatus as described in claim 1, said interconnected and elongated portions further comprising a plurality of inside connecting portions communicating with said hooks, a plurality of angled converging locations being established between said inside connection portions and a pair of intermediate elongate extending sides.

5. The spacer apparatus as described in claim 4, further comprising a plurality of elongated ends extending between outer ends of a pair of spaced apart hooks.

6. The spacer apparatus as described in claim 1, said interconnected and elongated portions further comprising three equiangular extending connecting portions extending between a conjoining midpoint, said hooks further including three outer hooks disposed at outer ends of each of said equiangular connecting portions.

7. The spacer apparatus as described in claim 1, said interconnected and elongated portions further comprising a pair of elongated and crosswise extending legs arranged in an X shape so as to define segmented portions intersecting at a central midpoint and extending outwardly to four corner located hooks.

8. The spacer apparatus as described in claim 1, said interconnected and elongated portions further comprising two inside connecting portions and two crossbars which function as additional crosswise extending and reinforcing wire frame supports.

9. The spacer apparatus as described in claim 8, further comprising said inside connecting portions being disposed parallel to each other and having two outer ends.

10. The spacer apparatus as described in claim 9, further comprising said crossbars being perpendicular to said inside connecting portions, and extend between and connect saod two inside connecting portions.

11. The spacer apparatus as described in claim 10, said hooks further comprising four hooks disposed at outer ends of each of said two inside connecting portions.

12. A combination rack and spacer apparatus for supporting a plurality of pans in a tiered and roller supported fashion, said combination comprising:
a first body having a base, from which upwardly extends a plurality of elongated members so as to define an open interior, a plurality of reinforcing support members arranged in end to end and perimeter defining fashion and which connect upper extending ends of the elongated members;
at least one second body having interconnected and elongated portions terminating in hooks at extending ends thereof;
said hooks adapted to engage perimeter displaced locations of the top edge and uppermost adjoining side surfaces of a first pan supported upon said base of said first body and between said plurality of elongated and upwardly extending members, said elongated portions extend across an interior of the pan between the base and top edge; and
an underside of a second pan arranged atop the first pan and adapted to contact said elongated portions so that the top edge and outer side surface of the second pan is upwardly spaced relative to the top edge and inner side surface of the first pan to permit airflow between therebetween.

13. The combination as described in claim 12, said second body further comprising castors extending from bottom corners of said base.

14. The combination as described in claim 12, said upwardly extending elongated members of said first body each further comprising an L-shaped cross-section.

15. The combination as described in claim 12, said first body further comprising a handle attached to one of said reinforcing support members.

16. The combination as described in claim 12, each of said hooks of said second body further comprising an outer end, an apex and an inner end disposed below said apex.

17. The combination as described in claim 12, said interconnected and elongated portions of said second body further comprising a plurality of inside connecting portions communicating with said hooks, a plurality of angled converging locations being established between said inside connection portions and a pair of intermediate elongate extending sides.

18. The combination as described in claim 17, said second body further comprising a plurality of elongated ends extending between outer ends of a pair of spaced apart hooks.

19. The combination as described in claim 12, said interconnected and elongated portions of said second body further comprising three equiangular extending connecting portions extending between a conjoining midpoint, said hooks further including three outer hooks disposed at outer ends of each of said equiangular connecting portions.

20. The combination as described in claim 12, said interconnected and elongated portions of said second body further comprising a pair of elongated and crosswise extending legs arranged in an X shape so as to define segmented portions intersecting at a central midpoint and extending outwardly to four corner located hooks.
